(19) United States
(12) Patent Application Publication
(10) Pub. No.: US 2006/0288154 A1
(43) Pub. Date: Dec. 21, 2006

(54) Data clearing methods and computer systems utilizing the same

(75) Inventors: Sin-Ru Huang, Taipei (TW); Jia-Han Li, Tainan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/211,973

(22) Filed: Aug. 25, 2005

(30) Foreign Application Priority Data
Jun. 21, 2005 (TW) 94120571

(51) Int. Cl. G06F 13/28

(52) U.S. Cl. 711/106

(57) ABSTRACT

A data clearing method. When a computer system boots, a dynamic random access memory (DRAM) therein is cleared by way of suspending refresh cycles thereof within a predetermined period of time.

### BACKGROUND

The invention relates to computer rebooting procedures, and in particular, to clearing data from main memories after rebooting.

Rebooting is important procedure for computers. For example, a computer must be rebooted when unable to recover from an error. Ideally, the main memory in the computer is subsequently cleared and data is reloaded. Conventional main memories lose data stored therein when not provided with electrical power. The time required for erasing main memory may vary in accordance with memory characteristics. A reboot operation may be so rapid that data remains in main memories.

Some embedded operating systems, such as Microsoft Windows CE, after being loaded in a rebooted computer, checks if any registry file exists in the main memory thereof. If so, the operating system continues using existing registry files without reloading. Invalid registry files may cause errors on the operating system. Hence, data must be cleared from main memories.

FIG. 1 is a flowchart of clearing data from the main memory of a conventional computer. When a computer reboots (step S2), respective components thereof are initialized (step S4). The computer identifies the capacity of the main memory (step S6) and deletes data therein conforming to the memory bandwidth (step S8). For example, main memory data may be deleted in byte units. Thus, the greater the memory capacity, the more time is consumed, potentially slowing bootup. Additionally, the time required to complete data deletion is hard to estimate.

Different memories may have different characteristics. Because dynamic random access memories (DRAM) are widely used as main memories, an enhanced data clearing method for DRAMs is desirable.

### SUMMARY

Accordingly, data clearing methods and computer systems utilizing the same are provided.

An exemplary embodiment of a data clearing method is implemented in a computer comprising a dynamic random access memory (DRAM). First, the computer is booted. Refresh cycles of the DRAM are suspended for a predetermined period to clear data from the DRAM.

A component of the computer system providing refresh cycles to the DRAM may be initialized before the predetermined period. Before the end of the predetermined period, components of the computer system other than the DRAM and the component providing refresh cycles to the DRAM may be initialized.

Additionally, the data clearing method can be implemented with a computer application recorded in a storage medium such as a memory or a memory device. The computer application, when loaded into a computer, directs the computer to execute the data clearing method.

An exemplary embodiment of a computer system comprises a dynamic random access memory (DRAM) and a processor coupled to the DRAM. When the computer boots, the processor suspends refresh cycles of the DRAM for a predetermined period to clear data from the DRAM.

The processor may initialize a component of the computer system providing refresh cycles to the DRAM before the predetermined period. Before the end of the predetermined period, the processor may initialize components of the computer system other than the DRAM and the component providing refresh cycles to the DRAM.

### DESCRIPTION OF THE DRAWINGS

The invention can be more fully understood by reading the subsequent detailed description and examples with references made to the accompanying drawings, wherein:

FIG. 1 is a flowchart of clearing data from the main memory of a conventional computer.

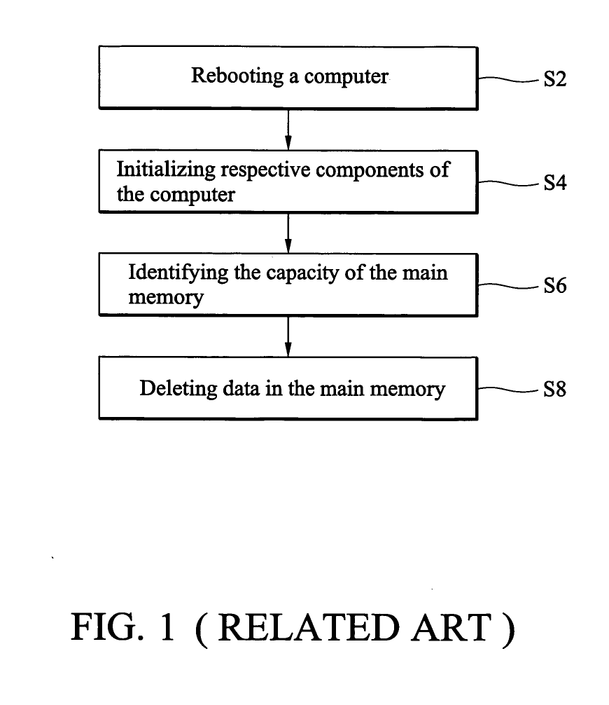

FIG. 2 is a block diagram of an exemplary embodiment of a computer.

FIG. 3 is a flowchart of the first embodiment of a method for clearing data from the DRAM.

FIG. 4 is a flowchart of step S24 in the first embodiment.

FIG. 5 is a flowchart of the second embodiment of a method for clearing data from the DRAM.

FIG. 6 is a schematic diagram of a first period T1 and a second period T2 in the second embodiment.

FIG. 7 is a flowchart of step S52 in the second embodiment.

FIG. 8 is a schematic diagram of a loader of the second embodiment.

FIG. 9 is a storage medium implementing the data clearing method.

### DETAILED DESCRIPTION

Time for clearing data from a main memory may vary by memory type. Many computer systems are equipped with Dynamic Random Access Memory (DRAM) due to cost considerations. Exemplary embodiments of data clearing methods for DRAMs and computer systems utilizing the same are provided.

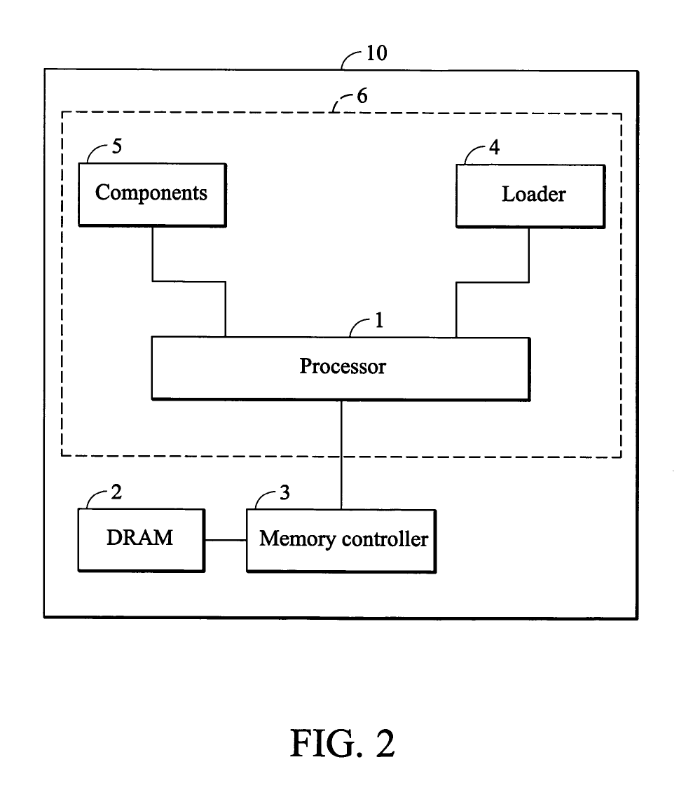

Computer 10 in FIG. 2 comprises processor 1, DRAM 2, memory controller 3, loader 4, and other components 5. Processor 1 is coupled to DRAM 2, memory controller 3, loader 4, and components 5. Computer 10 may be a personal computer (PC), a personal digital assistant (PDA), smart phone, a thin client, or other type of computer. Processor 1 may be the central processing unit (CPU) of computer 10. DRAM 2, as the main memory of computer 10, may pertain to any kind of DRAM requiring refresh cycles, such as Extended Data Out DRAM (EDO DRAM), Burst Extended Data Out DRAM (BEDO DRAM), Synchronous DRAM (SDRAM), and Double Data Rate-Synchronous DRAM (DDR-SDRAM).

Memory controller 3 provides and controls refresh cycles for DRAM 2. Note that some DRAMs are self-refreshing.

Loader 4 directs bootstraps for computer 10. For example, loader 4 directs initialization of respective components of computer 10, starting up of an operating system (OS) from a flash memory of computer 10, or loading of a portion of the OS to the main memory of computer 10 for execution. Loader 4 may comprise a read-only memory storing a plurality of instructions first read and executed by processor 1 at the beginning of a boot of computer 10. Loader 4 may be implemented by a computer program which may be stored in a memory of computer 10 and executed before execution of an OS of computer 10. Loader 4 may be a part of an OS or an external module connecting computer 10 through a communication port, such as a flash memory, an external hard drive, a Compact Flash (CF) Card, a Micro-drive, a Smart Media (SM) Card, a Multi Media Card (MMC), a Secure Digital (SD) Card, a Memory Stick, or another external storage device connected through Universal Serial Bus (USB).

Components 5 may comprise chipsets, various controllers, storage devices, or other devices. DRAM 2 and memory controller 3 must be initialized to provide refresh cycles. Component group 6 comprises other devices, such as processor 1, loader 4, and components 5 other than DRAM 2 and memory controller 3.

Computer 10 may have a power switch. After computer 10 operates for a period of time, DRAM 2 comprises various data and code. Computer 10 is rebooted utilizing the power switch. First and second exemplary embodiments of data clearing method are provided in the following, but are not limited to the described.

### First Embodiment

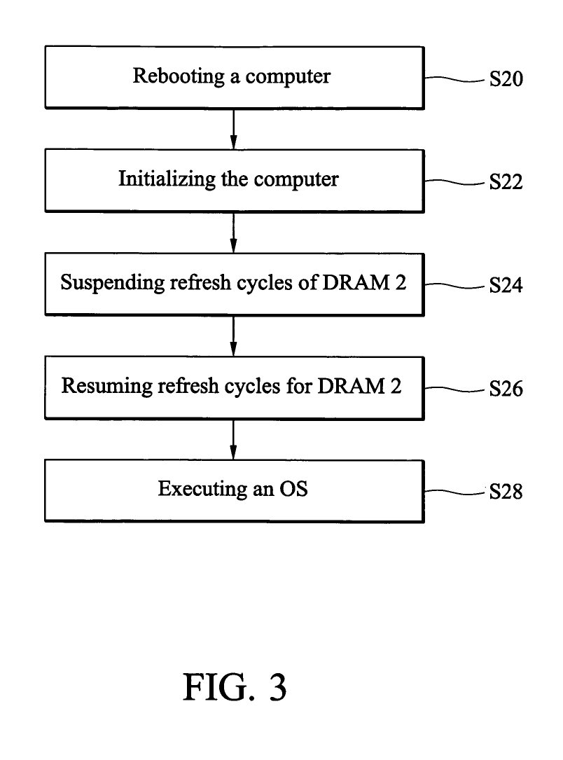

With reference to FIG. 3, computer 10 reboots (step S20). Processor 1 reads instructions from loader 4 and initializes computer system (step S22). For example, in the system initialization, processor 1 may initialize DRAM 2, memory controller 3, and other components 5 (such as chipsets and various controllers). Processor 1 controls memory controller 3 after the initialization thereof. Processor 1 suspends refresh cycles of DRAM 2 utilizing memory controller 3 (step S24). Without refresh cycles, DRAM 2 loses its data, and thus is erased.

Note that in the case of DRAMs self-refresh, processor 1 controls the DRAMs to suspend refresh cycles.

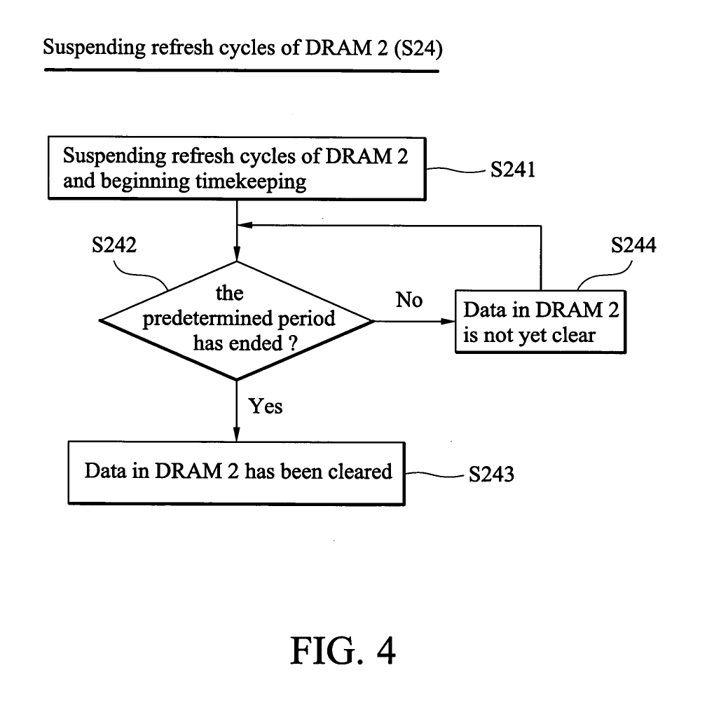

The time required for suspending refresh cycles may vary by DRAM specification. For example, the manufacturer of computer 10 knowing the time may assign and store a predetermined period in loader 4 before computer 10 leaves the factory. The predetermined period is long enough for clearing all data of DRAM 2. Processor 1 suspends recharging DRAM 2 for the predetermined period. The predetermined period may be measured with clock pulses or nanoseconds. Computer 10 may utilize a timer, a counter, or processor 1 to keep time. Under this condition, step S24 is described in further detail with reference to FIG. 4.

In step S24, processor 1 performs the following step in accordance with loader 4.

Processor 1 suspends refresh cycles of DRAM 2 and begins timekeeping (step S241). For example, a timer, a counter, or processor 1 may execute timekeeping. Processor 1 can initialize other components of computer 10 during the predetermined period. Processor 1 determines if the predetermined period has ended (step S242). If so, data in DRAM 2 is cleared (step S243), and processor 1 proceeds to step S26. If the predetermined period has not ended, data in DRAM 2 is not yet cleared (step S244), and step S242 is repeated.

After a period (such as the predetermined period) long enough to clear all data in DRAM 2, processor 1 controls memory controller 3 to resume refresh cycles for DRAM 2 (step S26). Loader 4 directs processor 1 to execute an OS (step S28). That is, processor 1 retrieves and executes an OS according to instructions of loader 4. The OS and loader 4 may be stored in the same memory or different memories. Thus, the OS is prevented from reading invalid data because DRAM 2 is erased in advance.

In the first embodiment, processor 1 may load instructions of loader 4 to DRAM 2 for execution, or directly read and execute from loader 4.

In the first embodiment, processor 1 suspends refresh cycles of DRAM 2 after initialization of relevant components.

### Second Embodiment

At least one component of the computer other than DRAM 2 and memory controller 3 is first initialized to continuously discharge and erase DRAM 2.

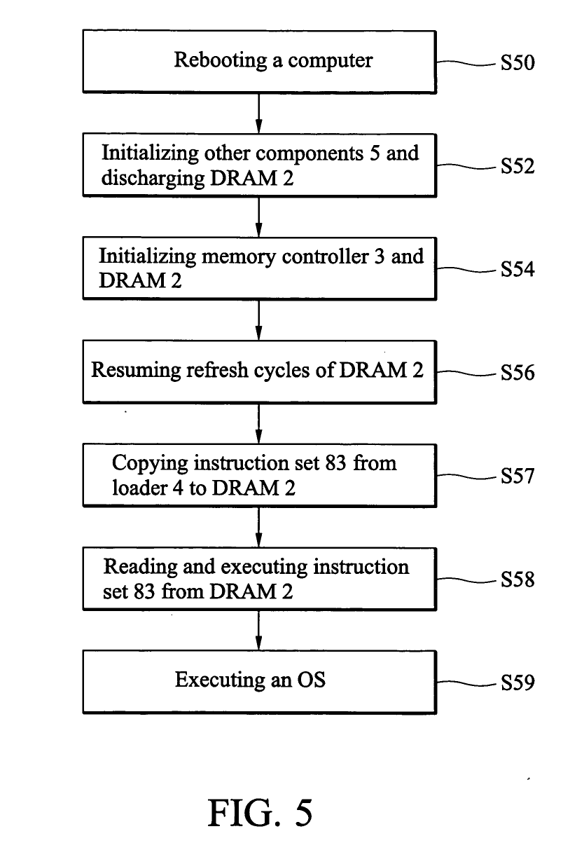

With reference to FIG. 5, computer 10 reboots (step S50). Processor 1 reads instructions from loader 4 and initializes computer system (steps S52 and S54). Unlike the first embodiment, during the system initialization, processor 1 first initializes other components 5 (such as chipsets and various controllers) other than DRAM 2 and memory controller 3 (step S52). In step S52, DRAM 2 has no refresh cycles. Accordingly, during initialization of components 5, memory cells in DRAM 2 discharge continuously to clear data (step S52). The period of initializing components 5 preferably is long enough to erase DRAM 2.

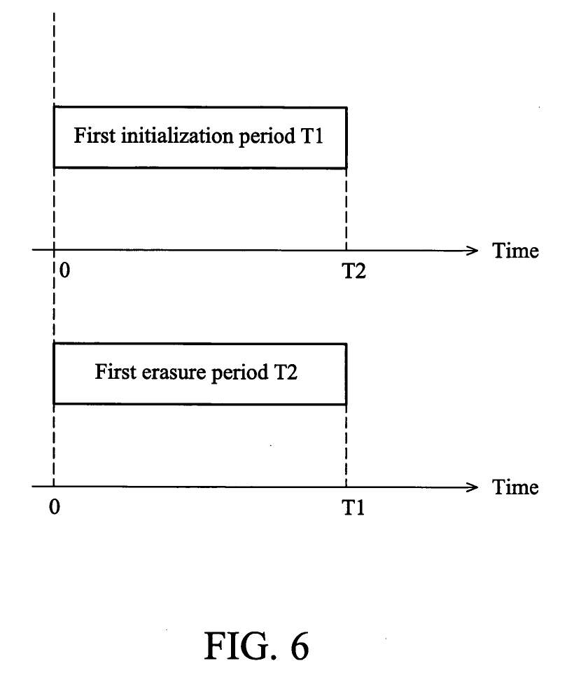

A first initialization period T1 and a first erasure period T2 are shown in FIG. 6. The first initialization period T1 is referred to as the period from starting computer 10 to completing initialization of component group 6. The first erasure period T2 is referred to as the period required to clear all data from DRAM 2 by suspending refresh cycles.

The first initialization period T1 and the first erasure period T2 may be measured before computer 10 leaves its factory. If the first initialization period T1 is greater than the first erasure period T2, DRAM 2 can be entirely erased before completing initialization of component group 6 shown in the FIG. 2. Under this condition, processor 1 can directly initialize memory controller 3 and DRAM 2 after step S52. If the first initialization period T1 is less than the first erasure period T2, DRAM 2 may not be entirely erased after initialization of component 5. Under this condition, a predetermined period may be assigned and stored in loader 4.

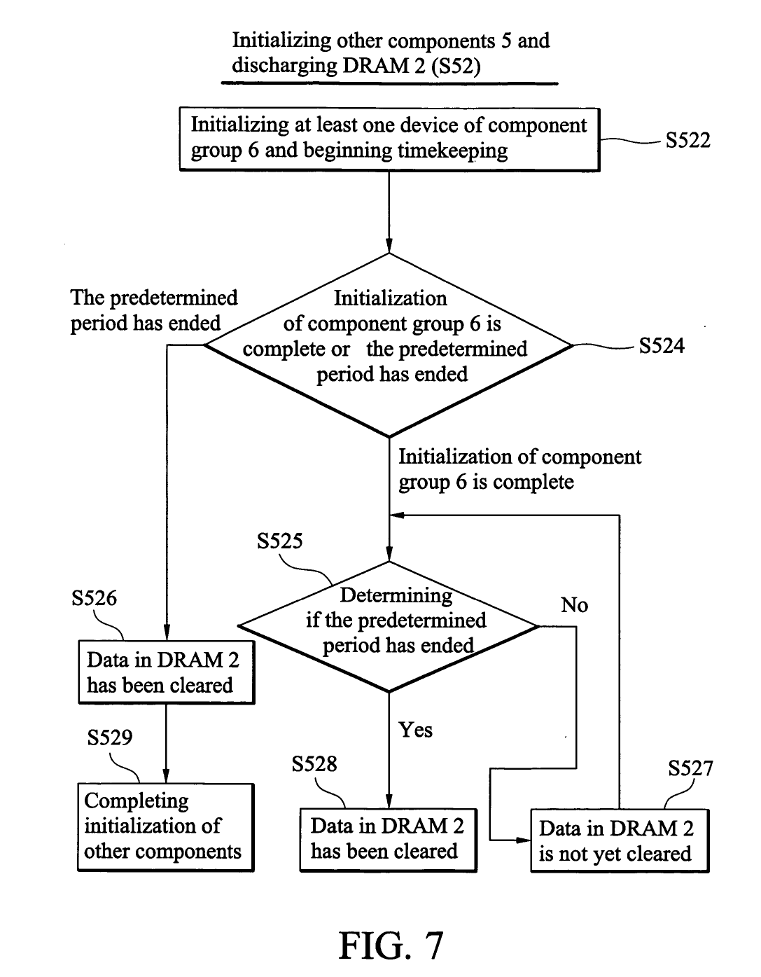

The predetermined period is greater than the first erasure period T2. In FIG. 7, processor 1 performs step S52 for the predetermined period. The first initialization period T1 depends on the hardware structure of the computer. For example, installing new devices to computer 10 may increase the first initialization period T1. Steps disclosed in FIG. 7 are also applicable when the first initialization period T1 varies.

In step S52, loader 4 directs processor 1 to perform the following steps.

Processor 1 initializes at least one device of component group 6, such as components 5, and begins timekeeping (step S522). A timer or a counter may perform timekeeping. Processor 1 determines if initialization of component group 6 is complete or if the predetermined period has ended (step S524). When initialization of component group 6 is complete, processor 1 determines if the predetermined period has ended (step S525). If so, data in DRAM 2 is cleared (step S528), and step S54 is subsequently performed. If the predetermined period has not yet ended, data in DRAM 2 is not yet clear (step S527), and step S525 is repeated.

When the predetermined period has ended, data in DRAM 2 is cleared (step S526). Processor 1 may complete initializing other components (step S529). After step S529, processor 1 may subsequently perform step S54. If some components have not been initialized after step S526, processor 1 may initialize the components, memory controller 3, and DRAM 2 in any order after step S526.

DRAM 2 is erased before step S54, and other components 5 of computer 10 have been initialized. Processor 1 then initializes memory controller 3 and DRAM 2 (step S54). Processor 1 can control memory controller 3 and DRAM 2.

Processor 1 controls memory controller 3 and DRAM 2 to resume refresh cycles of DRAM 2 (step S56).

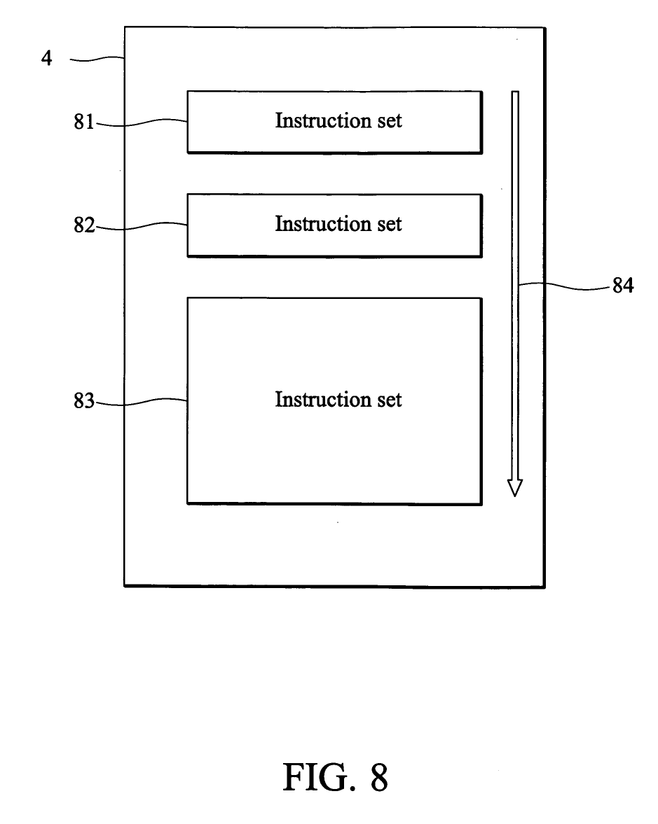

In the second embodiment, processor 1 can read instructions from loader 4 to perform the previously-described steps. If loader 4 comprises instructions for subsequent execution, please refer to FIG. 8.

Symbol 84 details the order in which instructions are executed. Loader 4 comprises instruction sets 81-83. Instruction set 81 directs processor 1 to perform steps S50-S56. Instruction sets 82-83 directs subsequent steps in the boot process of computer 10, comprising instructions directing processor 1 to perform steps S57 and S59. Instruction set 82 directs processor 1 to copy instruction set 83 to DRAM 2 (step S57), allowing processor 1 to read and execute instruction set 83 from DRAM 2 (step S58). If loader 4 comprises firmware such as a flash memory, the access rate of a DRAM is typically faster than that of loader 4. Thus, the efficiency of executing instruction set 83 by computer 10 may be enhanced. Instruction set 83 directs processor 1 to perform step S59. Note that steps S57 and S58 may be omitted, and step S59 can be directly performed after step S56.

Loader 4 then directs processor 1 to perform an OS (step S59). Since DRAM 2 is erased before step S59, the OS is prevented from reading old data remaining in DRAM 2.

In the second embodiment, other components rather than DRAM and memory controller 3 are initialized before the predetermined period. After the predetermined period, initialization of DRAM 2 and memory controller 3 begins. Thus DRAM 2 is erased before receiving refresh cycles.

A machine-readable storage medium storing a computer program is also provided. The computer program implements the data clearing method comprising the previously-described steps.

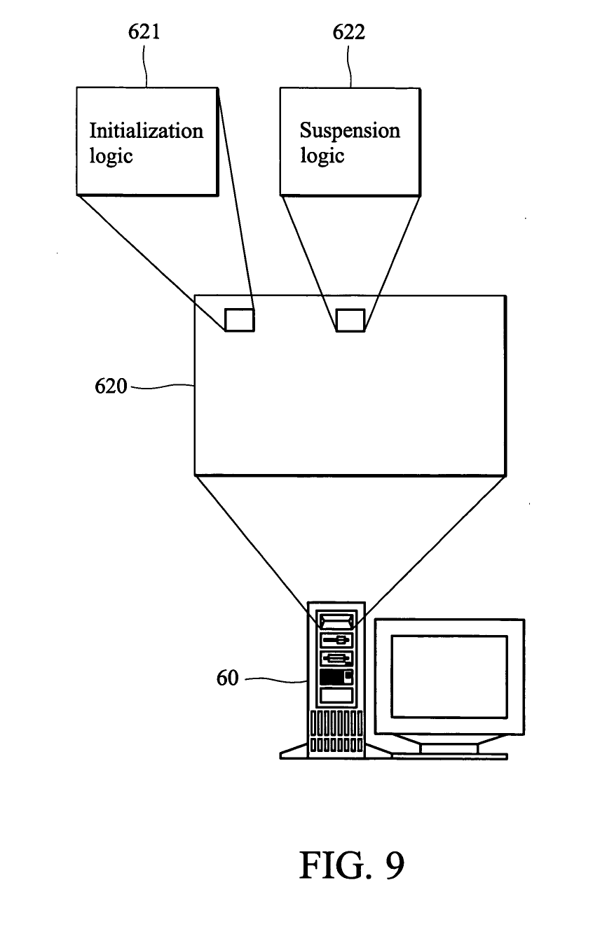

In FIG. 9 storage medium 60 stores a computer program 620 implementing the data clearing method. Computer program 620 comprises the initialization logic 621 and the refresh cycle suspension logic 622. Initialization logic 621 initializes a computer system. Refresh cycle suspension logic 622 suspends DRAM refresh cycles according to a predetermined period to erase DRAM.

Regardless of the main memory capacity, the time required to clear all data from a main memory is substantially equal to erasure period T2 and easy to estimate. The data clearing methods prevent old data from remaining in a main memory.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data clearing method, implemented in a computer comprising a dynamic random access memory (DRAM), comprising:
initiating the computer; and
suspending refresh cycles of the DRAM for a predetermined period to clear data from the DRAM.

2. The method as claimed in claim 1, wherein the computer performs the suspending step before executing an operating system (OS).

3. The method as claimed in claim 1, wherein the computer performs the suspending step after initializing a component thereof providing refresh cycles to the DRAM.

4. The method as claimed in claim 3, wherein the computer performs the suspending step utilizing a memory controller comprising the component providing refresh cycles to the DRAM.

5. The method as claimed in claim 1, wherein after the predetermined period, the computer initializes the DRAM and a component providing refresh cycles to the DRAM.

6. The method as claimed in claim 5, wherein before the end of the predetermined period, the computer initializes components thereof other than the DRAM and the component providing refresh cycles to the DRAM.

7. The method as claimed in claim 1, wherein the computer comprises a read-only memory (ROM), when the computer boots, instructions in the ROM direct the computer to perform the suspending step, further comprising, after the predetermined period, loading instructions to be executed from the ROM to the DRAM for execution.

8. A computer system, comprising:
a dynamic random access memory (DRAM) coupled to a memory controller; and
a processor coupled to the memory controller, suspending refresh cycles of the DRAM for a predetermined period to clear data from the DRAM when the computer boots.

9. The system as claimed in claim 8, wherein the processor suspends the refresh cycles before executing an operating system (OS).

10. The system as claimed in claim 8, wherein the processor suspends the refresh cycles after initializing a component of the computer system providing refresh cycles to the DRAM.

11. The system as claimed in claim 10, wherein the processor suspends the refresh cycles utilizing the memory controller comprising the component providing refresh cycles to the DRAM.

12. The system as claimed in claim 8, wherein after the predetermined period, the processor initializes the DRAM and a component of the computer system providing refresh cycles to the DRAM.

13. The system as claimed in claim 12, wherein before the end of the predetermined period, the processor initializes components of the computer system other than the DRAM and the component providing refresh cycles to the DRAM.

14. The system as claimed in claim 8, wherein the computer system comprises a read-only memory (ROM), when the computer system boots, instructions in the ROM direct the processor to suspend the refresh cycles, and, after the predetermined period, the processor loads instructions to be executed from the ROM to the DRAM for execution.

15. A computer-readable storage medium storing a computer program which, when executed, directs a computer comprising a dynamic random access memory (DRAM) to perform a data clearing method, the method comprising the steps of:
when the computer boots, initializing a component thereof providing refresh cycles to the DRAM; and
suspending refresh cycles of the DRAM for a predetermined period by controlling the component.

16. The computer-readable storage medium as claimed in claim 15, wherein the computer performs the suspending step before executing an operating system (OS).

17. The computer-readable storage medium as claimed in claim 15, wherein the computer performs the suspending step utilizing a memory controller comprising the component providing refresh cycles to the DRAM.

18. The computer-readable storage medium as claimed in claim 15, wherein before the end of the predetermined period, the computer initiates components thereof other than the DRAM and the component providing refresh cycles to the DRAM.

19. The computer-readable storage medium as claimed in claim 15, wherein the storage medium is a read-only memory (ROM), the method further comprises, after the predetermined period, loading instructions to be executed from the ROM to the DRAM for execution.
